(19) United States
(12) Patent Application Publication
(10) Pub. No.: US 2026/0117341 A1
(43) Pub. Date: Apr. 30, 2026

(54) LEAD-RECOVERY PROCESS

(71) Applicant: KC RECYCLING, LTD., Trail (CA)

(72) Inventor: Odillo Piotto, Trail (CA)

(21) Appl. No.: 19/368,813

(22) Filed: Oct. 24, 2025

Related U.S. Application Data
(60) Provisional application No. 63/712,174, filed on Oct. 25, 2024.

(51) Int. Cl. C22B 13/02; B01D 46/02; B01D 47/02; B01D 50/60; C01B 17/74; C01C 1/242; C01C 1/245; C22B 1/02; C22B 5/12; C22B 7/00; H01M 6/52; H01M 10/54

(52) U.S. Cl. CPC C22B 13/025; B01D 46/02; B01D 47/02; B01D 50/60; C01B 17/74; C01C 1/242; C01C 1/245; C22B 1/02; C22B 5/12; C22B 7/001; H01M 6/52; H01M 10/54

(57) ABSTRACT

A process for recovery lead including providing lead-bearing material. The lead-bearing material includes lead sulfate (PbSO₄). The lead-bearing material is heated resulting in the formation of gaseous sulfur compounds and lead oxide. The gaseous sulfur compounds and the lead oxide are separated. The lead oxide is lanced with a hydrocarbon resulting in the formation of lead (Pb) and carbon dioxide (CO₂). The lead and the carbon dioxide are separated.

### CROSS-REFERENCE TO RELATED APPLICATIONS

This application claims priority to and benefit of U.S. Provisional Patent Application No. 63/712,174 filed Oct. 25, 2024, which is incorporated by reference herein in its entirety.

### FIELD OF THE INVENTION

The present invention relates generally to a process for recovering lead. More specifically, the present invention relates to a process for recovering lead from lead-bearing material that typically includes sulfur.

### BACKGROUND OF THE INVENTION

Smelting processes have been used for many years to extract a desired metal product. Smelting in one process applies heat with a chemical reducing agent to an ore to extract the desired metal product. One example of smelting involves recycled lead-bearing material including, for example, lead sulfate (PbSO₄).

To assist in controlling sulfur emissions, various chemicals have been added to the smelting processes including, but not limited to, sodium ash (sodium carbonate), caustic soda (sodium hydroxide (NaOH)), cast iron, carbon (e.g., charcoal, anthracite), lime or combinations thereof. These chemicals assist in desulfurizing the lead-bearing material before being heated in a furnace. By adding chemicals, more waste product has been created in the smelting process. This additional generated waste product is often of much lower value, and will typically later be neutralized and disposed because of the time and expense involved in further refining the waste product.

This generated waste product in the smelting process tends to be hazardous material. More specifically, the hazardous material tends to have a pH greater than 12.5, which is caused by sodium ash or caustic acid. Because of the high pH, the generated waste product needs to be treated. The hazardous material often include soluble hydroxides therein. Even if the pH is lowered in the treatments, they tend to release lead and other heavy metals. The added chemicals also occupy valuable capacity in the furnace, reducing the ability to add more lead-bearing material in the smelting process. Thus, in summary, the added chemicals assisting in desulfurizing the lead-bearing material in the process: (1) produce a significant amount of hazardous waste product; (2) result in inefficient use of furnace capacity; (3) are costly; and (4) increase the process time and associated processing costs.

It would be desirable to provide a process for recovering lead that addresses the above problems with existing smelting process, while still efficiently separating sulfur and lead.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings and each claim.

According to one process of the present disclosure, lead is recovered. Lead-bearing material is provided and includes lead sulfate (PbSO₄). The lead-bearing material is heated resulting in the formation of gaseous sulfur compounds and lead oxide. The gaseous sulfur compounds and the lead oxide are separated. The lead oxide is lanced with a hydrocarbon resulting in the formation of lead (Pb) and carbon dioxide (CO₂). The lead and the carbon dioxide are separated.

According to a further configuration of the above implementation, the hydrocarbon is a gaseous hydrocarbon. The gaseous carbon includes methane (CH₄), ethane (C₂H₆), propane (C₃H₈), butane (C₄H₁₀), or any combination thereof.

In a further aspect of the above implementation, the heating of the lead-bearing material occurs in a furnace at a temperature greater than about 900° C. and in another implementation, the heating of the lead-bearing material occurs in a furnace at a temperature from about 900° C. to about 1,300° C.

In a further aspect of the above implementation, the gaseous sulfur compounds are reacted with water to form sulfuric acid (H₂SO₄). The sulfuric acid (H₂SO₄) may be reacted with ammonia (NH₄) or urea (CO(NH₂)₂) to form ammonium sulfate ((NH₄)₂SO₄).

In yet a further aspect of the above implementation, the lead oxide includes PbO and PbO₂.

In a further aspect of the above implementation, the lead-bearing battery includes lead from scrap batteries.

According to a configuration of the above implementation, the lancing forms non-hazardous slag.

According to a further configuration of the above implementation, the heating of the lead-bearing material is performed in a tilting furnace, a reverberatory furnace or a rotary furnace.

According to another process of the present disclosure, lead is recovered. Lead-bearing material is provided and includes lead sulfate (PbSO₄). The lead-bearing material is heated resulting in the formation of gaseous sulfur compounds and lead oxide. The gaseous sulfur compounds and the lead oxide are separated. The lead oxide is lanced with a hydrocarbon resulting in the formation of lead (Pb) and carbon dioxide (CO₂). The lead and the carbon dioxide are separated. The heating of the lead-bearing material is performed in the absence of chemicals.

According to a further configuration of the above implementation, the lancing of the lead oxide is performed in the absence of chemicals.

In a further aspect of the above implementation, the gaseous sulfur compounds are reacted with water to form sulfuric acid (H₂SO₄). The sulfuric acid (H₂SO₄) may be reacted with ammonia (NH₄) or urea (CO(NH₂)₂) to form ammonium sulfate ((NH₄)₂SO₄).

According to a further process of the present disclosure, lead is recovered. Lead-bearing material is provided. The lead-bearing material is heated resulting in the formation of lead oxide. The lead oxide is lanced with a hydrocarbon resulting in the formation of lead (Pb) and carbon dioxide (CO₂). The lead and the carbon dioxide are separated.

In a further aspect of the above implementation, the heating of the lead-bearing material is performed in the absence of chemicals.

In a further aspect of the above implementation, the lancing of the lead oxide is performed in the absence of chemicals.

In a further aspect of the above implementation, the gaseous sulfur compounds are reacted with water to form sulfuric acid (H₂SO₄). The sulfuric acid (H₂SO₄) may be reacted with ammonia (NH₄) or urea (CO(NH₂)₂) to form ammonium sulfate ((NH₄)₂SO₄).

According to one process of the invention, metallic lead is produced from scrap lead-acid batteries. Scrap lead-acid batteries are processed to separate lead-bearing material from non-lead bearing material. Sulfur is removed from the lead-bearing material to produce desulfurized lead-bearing material. A gaseous hydrocarbon is introduced to the desulfurized lead-bearing material to produce metallic lead.

In an aspect of the above process, the step of processing the scrap lead-acid batteries comprises crushing or milling the scrap lead-acid batteries.

In an aspect of the above process, the step of processing the scrap lead-acid batteries comprises separation by density.

In an aspect of the above process, the step of processing the scrap lead-acid batteries comprises solubilizing the lead-bearing material. In embodiments, the step of processing the scrap lead-acid batteries comprises solubilizing PbSO₄.

In an aspect of the above process, the step of processing the scrap lead-acid batteries comprises removal of electrolyte. In embodiments, the step of processing the scrap lead-acid batteries comprises removal of sulfuric acid.

In an aspect of the above process, the lead-bearing material comprises PbSO₄, PbO, PbO₂, Pb, or PbCO₃. In embodiments, the lead-bearing material comprises PbSO₄. In embodiments, the lead-bearing material comprises PbO₂. In embodiments, the lead-bearing material comprises PbO. In embodiments, the lead-bearing material comprises Pb. In embodiments, the lead-bearing material comprises PbCO₃.

As used herein, “desulfurized lead-bearing material” refers to a lead-bearing material that is substantially free of sulfur. Some residual sulfur may be present in “desulfurized lead-bearing material.” In embodiments, a desulfurized lead-bearing material comprises less than about 1% S, 2% S, 3% S, 4% S, or 5% S by mass. In embodiments, a desulfurized lead-bearing material comprises less than about 1% S by mass. In embodiments, a desulfurized lead-bearing material comprises less than about 2% S by mass. In embodiments, a desulfurized lead-bearing material comprises less than about 3% S by mass.

In a further aspect of the above process, removing sulfur from the lead-bearing material comprises heating the lead-bearing material. In embodiments, the lead-bearing material is heated to a temperature sufficient to melt the lead-bearing material. In embodiments, the lead-bearing material is heated to a temperature that is sufficient to drive the production of gaseous sulfur compounds from the lead-bearing material. In embodiments, the lead-bearing material is heated to a temperature that is sufficient to decompose PbSO₄. The required temperature may vary with identify of the lead-bearing material. For example, elimination or reduction in the use of fluxes, or the relative proportions of lead species in the lead-bearing material, may increase or decrease the melting point of the lead-bearing material.

In embodiments, the lead-bearing material is heated to a temperature greater than about 600° C., 800° C., 1000° C., or 1200° C. In embodiments, the lead-bearing material is heated to a temperature greater than about 600° C. In embodiments, the lead-bearing material is heated to a temperature greater than about 800° C. In embodiments, the lead-bearing material is heated to a temperature greater than about 1000° C.

In embodiments, the lead-bearing material is heated to a temperature between about 600° C. to about 1200° C., between about 800° C. to about 1200° C., or between about 1000° C. to about 1200° C. In embodiments, the lead-bearing material is heated to a temperature between about 600° C. to about 1200° C. In embodiments, the lead-bearing material is heated to a temperature between about 800° C. to about 1200° C. In embodiments, the lead-bearing material is heated to a temperature between about 1000° C. to about 1200° C.

In a further aspect of the above process, removing sulfur from the lead-bearing material is performed in the absence of a metallurgical flux. As used herein, “metallurgical flux” and “added chemicals” refer to any substance added during smelting which forms an immiscible slag that can be separated from the metallic product. In embodiments, the step of removing sulfur from the lead-bearing material is performed in the absence of a metallurgical flux. In embodiments, the step of removing sulfur from the lead-bearing material is performed in the absence of a solid carbon source. In embodiments, the step of removing sulfur from the lead-bearing material is performed in the absence of coal, coke, or anthracite. In embodiments, the step of removing sulfur from the lead-bearing material is performed in the absence of calcium carbonate, potassium carbonate, sodium carbonate, or limestone. In embodiments, the step of removing sulfur from the lead-bearing material is performed in the absence of silica. In embodiments, the step of removing sulfur from the lead-bearing material is performed in the absence of iron.

In embodiments, the step of removing sulfur from the lead-bearing material further comprises production of a gaseous sulfur compound. In embodiments, the gaseous sulfur compound is SO₂, SO₃, or H₂S.

In another aspect of the above process, the desulfurized lead-bearing material comprises greater than about 40%, about 45%, about 50%, about 55%, about 60%, about 65%, about 70%, about 75%, about 80%, about 85%, about 90%, about 95%, or more of lead (II) oxide by mass. In embodiments, the desulfurized lead-bearing material comprises greater than about 50% lead (II) oxide by mass. In embodiments, the desulfurized lead-bearing material comprises greater than about 60% lead (II) oxide by mass. In embodiments, the desulfurized lead-bearing material comprises greater than about 70% lead (II) oxide by mass. In embodiments, the desulfurized lead-bearing material comprises greater than about 80% lead (II) oxide by mass. In embodiments, the desulfurized lead-bearing material comprises greater than about 90% lead (II) oxide by mass.

In a further aspect of the above process, the gaseous hydrocarbon source comprises a gaseous alkane. As used herein, “alkane” refers to any molecule comprising only carbon and hydrogen atoms connected by single bonds. As used herein, “C₁-C₆ alkane,” refers to the series of alkanes having 1-6 carbon atoms, including “C₁-alkane” (methane; CH₄), “C₂-alkane” (ethane; C₂H₆), “C₃-alkane” (propane; C₃H₈), “C₄-alkane” (butane; C₄H₁₀), “C₅-alkane” (pentane; C₅H₁₂), and “C₆-alkane” (hexane; C₆H₁₄).

In a further aspect of the above process, the gaseous hydrocarbon comprises a C₁-C₆ alkane. In embodiments, the gaseous hydrocarbon comprises methane. In embodiments, the gaseous hydrocarbon comprises ethane. In embodiments, the gaseous hydrocarbon comprises propane. In embodiments, the gaseous hydrocarbon comprises butane.

In a further aspect of the above process, the gaseous hydrocarbon comprises methane (CH₄), ethane (C₂H₆), propane (C₃H₈), butane (C₄H₁₀), or any combination thereof.

To facilitate the reduction of lead oxide to metallic lead in the absence of pyrometallurgical fluxes, a gaseous hydrocarbon is used as reductant. In an aspect, the gaseous hydrocarbon is introduced to the desulfurized lead material by a lance. In embodiments, the lance is moveable. In embodiments, the lance is submerged in the desulfurized lead-bearing material. In embodiments, the lance comprises stainless steel. In embodiments, the lance has a circular cross-section. In embodiments, the lance has a wear-resistant ceramic coating on an inner or outer surface.

In an aspect of the above process, the amount of gaseous hydrocarbon introduced is in a stoichiometric excess relative to the moles of PbO in the desulfurized lead-bearing material. In embodiments, the amount of gaseous hydrocarbon introduced is in a 1.5:1 stoichiometric excess relative to the moles of PbO in the desulfurized lead-bearing material. In embodiments, the amount of gaseous hydrocarbon introduced is in a 2:1 stoichiometric excess relative to the moles of PbO in the desulfurized lead-bearing material. In embodiments, the amount of gaseous hydrocarbon introduced is in a 3:1 stoichiometric excess relative to the moles of PbO in the desulfurized lead-bearing material.

In a further aspect of the above process, the amount of gaseous hydrocarbon introduced is greater than about 3 ft³ per kg of PbO in the desulfurized lead-bearing material. In embodiments, the amount of gaseous hydrocarbon introduced is greater than about 5% by mass of the PbO in the desulfurized lead-bearing material.

In embodiments, the process further comprises separating metallic lead from slag. In embodiments, the process further comprises refining the metallic lead to a desired purity. In embodiments, the process further comprises measuring the purity of the metallic lead.

In a further aspect of the above process, the step of introducing a gaseous hydrocarbon to the desulfurized lead-bearing material is performed in the absence of a metallurgical flux. In embodiments, the step of introducing a gaseous hydrocarbon to the desulfurized lead-bearing material is performed in the absence of a solid carbon source. In embodiments, the step of introducing a gaseous hydrocarbon to the desulfurized lead-bearing material is performed in the absence of coal, coke, or anthracite. In embodiments, the step of introducing a gaseous hydrocarbon to the desulfurized lead-bearing material is performed in the absence of calcium carbonate, potassium carbonate, sodium carbonate, or limestone. In embodiments, the step of introducing a gaseous hydrocarbon to the desulfurized lead-bearing material is performed in the absence of silica. In embodiments, the step of introducing a gaseous hydrocarbon to the desulfurized lead-bearing material is performed in the absence of iron.

According to one process of the invention, metallic lead is produced from a desulfurized lead-bearing material. A desulfurized lead-bearing material comprising lead oxide is provided. A gaseous reducing agent is introduced to the desulfurized lead-bearing material to produce metallic lead.

In a further aspect of the above process, the gaseous reducing agent is hydrogen, carbon monoxide, a metal vapor, or a gaseous hydrocarbon. In embodiments, the gaseous reducing agent is hydrogen. In embodiments, the gaseous reducing agent is carbon monoxide. In embodiments, the gaseous reducing agent is a metal vapor. In embodiments, the gaseous reducing agent is a gaseous hydrocarbon.

In a further aspect of the above process, the gaseous hydrocarbon comprises a C₁-C₆ alkane. In embodiments, the gaseous hydrocarbon comprises methane. In embodiments, the gaseous hydrocarbon comprises ethane. In embodiments, the gaseous hydrocarbon comprises propane. In embodiments, the gaseous hydrocarbon comprises butane.

In a further aspect of the above process, the gaseous reducing agent is introduced to the desulfurized lead bearing material by a lance.

In another aspect, the present disclosure provides a system for processing scrap lead-acid batteries to produce lead. The system comprises a furnace for heating the lead-bearing material at a temperature and time sufficient to remove sulfur present in the lead-bearing material, a separation system for separating gaseous sulfur species produced by heating the lead-bearing material, and a source of a gaseous hydrocarbon connected to the furnace and constructed and arranged to introduce the gaseous hydrocarbon to the desulfurized lead-bearing material in an amount and for a period of time sufficient to produce metallic lead.

In a further aspect of the above system, the furnace body comprises an electric furnace, a rotary furnace, a tilting furnace, or a reverberatory furnace.

In an aspect of the above system, the source of a gaseous hydrocarbon is arranged in connection with a lance. In embodiments, the lance is moveable relative to the furnace. In embodiments, the lance is arranged inside of the furnace. In embodiments, the lance is resistant to temperatures greater than about 1000° C., greater than about 1200° C., or greater than about 1400° C. In embodiments, the lance comprises stainless steel. In embodiments, the lance is a stainless steel lance or ceramic lance. In embodiments, the lance is a stainless steel lance.

In another aspect of the above system, the source of the gaseous hydrocarbon is constructed and arranged to introduce the gaseous hydrocarbon to the desulfurized lead-bearing material at a pressure of between about 10 psi to about 40 psi.

In a further aspect of the above system, the separation system comprises a baghouse system.

In a further aspect of the above system, the separation system comprises a wet scrubber system. In embodiments, the separation system filters a gaseous sulfur compound such as H₂S, SO₂ or SO₃.

In a further aspect of the above process, the source of the gaseous hydrocarbon comprises a C₁-C₆ alkane. In embodiments, the gaseous hydrocarbon comprises methane. In embodiments, the gaseous hydrocarbon comprises ethane. In embodiments, the gaseous hydrocarbon comprises propane. In embodiments, the gaseous hydrocarbon comprises butane.

In a further aspect of the above system, the gaseous hydrocarbon source comprises methane (CH₄), ethane (C₂H₆), propane (C₃H₈), butane (C₄H₁₀), or any combination thereof.

In another aspect, the present disclosure provides a process of retrofitting a smelting system. The process comprises providing a lance in connection with a source of a gaseous hydrocarbon; and, positioning the lance in connection with the source of gaseous hydrocarbon with a furnace of the smelting system.

The above summary is not intended to represent each embodiment or every aspect of the present invention. Additional features and benefits of the present invention are apparent from the detailed description and figures set forth below.

### BRIEF DESCRIPTION OF THE DRAWINGS

Other advantages of the invention will become apparent upon reading the following detailed description and upon reference to the drawings in which:

FIG. 1 is a flow chart of recovering lead according to one process.

FIG. 2 is a flow chart for refining gaseous sulfur compounds according to one process.

FIG. 3 is a flow chart for refining gaseous sulfur compounds according to another process.

FIG. 4 is a flow chart of recovering lead according to another process.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various embodiments are described with reference to the attached figures, where like reference numerals are used throughout the figures to designate similar or equivalent elements. The figures are not drawn to scale and are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details, or with other methods. In other instances, well-known structures or operations are not shown in detail to avoid obscuring the invention. The various embodiments are not limited by the illustrated ordering of acts or events, as some acts may occur in different orders and/or concurrently with other acts or events. Furthermore, not all illustrated acts or events are required to implement a methodology in accordance with the present invention.

The term “about” is used herein to mean within the typical ranges of tolerances in the art. For example, “about” can be understood as about 2 standard deviations from the mean. In embodiments, “about” means±10%. In embodiments, “about” means±5%. When about is present before a series of numbers or a range, it is understood that “about” can modify each of the numbers in the series or range.

The present process may be referred to a smelting process where in embodiments the sulfur context is reduced or removed, reduction occurs in a furnace at high temperatures, and refining to separate lead from other metals occurs.

The present processes in one method are configured to efficiently separate sulfur and lead found in lead-bearing material that includes lead sulfate (PbSO₄). The lead-bearing material to be used in the process may come from a variety of sources or products. For example, scrap batteries, lead ore, or other lead scrap (e.g., lead sheets, lead plates, dross, lead oxides, lead paste, etc.) may be used as the lead-bearing material. Scrap batteries include battery lead paste having a higher sulfur context, lead posts or poles that include other metals (e.g., antimony and tin), and other lead-bearing components. Dross is a lead-bearing material that is typically reprocessed to recover more lead therefrom. It is desirable to use lead materials with reduced or little contaminants such as lead from scrap batteries. Many of the other lead sources include contaminants such as silver and tellurium.

In embodiments, the lead-bearing material is sourced from scrap lead-acid batteries. Typically, a scrap lead-acid battery consists of 30% to 40% lead paste, 10% to 30% electrolyte, 20% to 30% lead pole/lead alloy grid, and 20% to 30% organic material such as polypropylene. The lead-bearing material from scrap batteries comprises Pb, PbO, PbO₂, and PbSO₄.

In embodiments, the lead-bearing material is sourced from a lead ore such as galena (PbS).

In embodiments, the present processes comprise dismantling a scrap lead-acid battery. Dismantling may be used to separate the batteries into, e.g., electrolyte, lead-bearing components, and non-lead bearing components.

In embodiments, separating the lead-bearing components and non-lead bearing components comprises separation by density. In embodiments, separating the lead-bearing components and non-lead bearing components comprises use of a sink/float cell.

In embodiments, the present processes comprise crushing or milling the lead-bearing material into an appropriate size. Processing of lead-acid batteries may comprise a step described in U.S. Pat. Nos. 3,892,563, 4,118,219, or U.S. Pat. No. 5,690,718, each of which is incorporated herein by reference.

The present processes are configured to be performed in the absence of added chemicals, which reduce costs and enable greater and more efficient use of furnace capacity. By not adding iron to the process, for example, the present process can operate at lower temperatures because a higher temperature is not needed to melt the iron. This results in faster processing and less energy required to get to the desired melting points of the lead-bearing material. In typical lead smelting processes, various chemicals are added to facilitate extraction of the base metal. The added chemicals, also called “metallurgical fluxes,” act as reducing agents or for removing impurities from the molten metal. Common fluxes used as reducing agents include solid carbonaceous sources such as coke, coal, graphite, carbon black, wood charcoal, and anthracite. Other non-limiting examples of fluxes include calcium carbonate, potassium carbonate, sodium carbonate, and limestone. Metals such as iron or oxides thereof such as magnetite may be used as metallurgical fluxes for various reasons. The use of fluxes in lead-acid battery recycling leads to decreased furnace capacity and increased energy costs. Moreover, after smelting, the fluxes are left behind as metallurgical “slags.” These slags pose serious environmental concerns due to their high pH values (typically greater than 12.5) and heavy metal content.

In embodiments, the metallurgical flux is a solid carbon source. In embodiments, the metallurgical flux is coal, coke, or anthracite. In embodiments, the metallurgical flux is calcium carbonate, potassium carbonate, sodium carbonate, or limestone. In embodiments, the metallurgical flux is silica. In embodiments, the metallurgical flux is iron.

In an aspect, the present processes increase furnace capacity by eliminating the use of pyrometallurgical fluxes. In embodiments, the present processes increase furnace capacity by about 5%, about 10%, or about 15% by eliminating the use of a solid carbon source as a pyrometallurgical flux. In embodiments, the present processes increase furnace capacity by about 5%, about 10%, about 15%, about 20% or more by eliminating or reducing the use of iron as a pyrometallurgical flux. In embodiments, the present processes increase furnace capacity by about 5%, about 10%, or about 15% by eliminating or reducing the use of calcium carbonate as a pyrometallurgical flux. In one embodiment, the furnace capacity can be increased by at least 5 percent by the reduction or absence of added chemicals. In other embodiments, the furnace capacity can be increased by at least 10 percent or at least 15 percent because of the reduction or absence of added chemicals. By reducing or eliminating extensive amount of chemicals, the capacity of the furnace is initially directed only to the lead-bearing material.

In embodiments, the furnace capacity can be increased by greater than about 10%, greater than about 20%, greater than about 30%, greater than about 40%, greater than about 50% or more compared to a process using added chemicals.

The present process also minimizes the amount of slag formed, especially compared with existing smelting processes. Slag is a waste material or by-product that is formed in the present process. The slag formed in the present process is typically non-hazardous.

The slag formed in the present process does not have a high pH. The slag formed in the present process has a pH less than 12.5 or, more specifically, less than 11 or 10. The slag formed in the present process generally has a pH from about 6 to about 11 and, more specifically, from about 7 to about 10. The slag formed in the present process desirably passes the Toxicity Characteristics Leaching Procedure (T-Clip), which is a chemical analysis process to determine (1) whether hazardous elements are present in the slag, (2) the mobility of hazardous elements in the slag, (3) the amount of EPA-listed contaminants in the slag, and (4) the likelihood of these contaminants being absorbed in soil and ground water.

By minimizing the amount of slag formed and also forming a more desirably type of slag (i.e., non-hazardous) in the present process, the disposal costs are lowered and the amount of reprocessing is reduced. By reducing the amount of slag that needs to be reprocessed enables the furnace to initially increase the amount of lead-bearing material added thereto. Thus, in other words, the furnace has a greater capacity to receive lead-bearing material. The reduction or elimination of hazardous slag also lowers liability and regulatory risk. The present lead-recovery process in an overall context reduces emissions and byproducts, which is beneficial.

In one process for recovery of lead, lead-bearing material is provided including lead sulfate (PbSO₄). The lead-bearing material is heated or roasted resulting in the formation of gaseous sulfur compounds and lead oxide (PbO₂). The gaseous sulfur compounds and the lead oxide are separated. The lead oxide is lanced with a hydrocarbon resulting in the formation of lead (Pb) and carbon dioxide (CO₂). The lead and the carbon dioxide are separated.

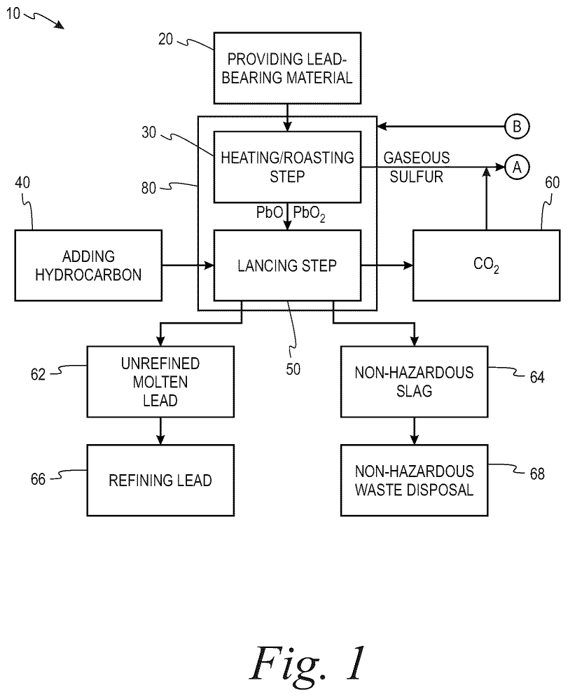

Referring to FIG. 1, a process flow chart 10 is shown for recovering lead according to one process. The process flow chart of FIG. 1 includes step 20 that provides lead-bearing material including lead sulfate (PbSO₄). The lead-bearing material used in the process will eventually separate the sulfur and lead contained therein. The lead-bearing material often includes recycled lead-bearing material.

The lead-bearing material to be used in step 20 may come from different sources including, but not limited to, scrap batteries, lead ore, or other lead scrap (e.g., lead sheets, lead plates, dross, lead oxides, lead paste, etc.). Before being processed, the scrap batteries are broken down into polymeric chips (e.g., polypropylene chips), lead paste, and metallic lead. The lead paste and metallic lead may be used as the lead-bearing material of step 20. As discussed above, it is desirable to use lead from scrap batteries of step 20. The lead-bearing material to be added may vary in the amount of sulfur included therein. A lead-bearing material may contain a higher amount of sulfur (from about 2 to about 6%) such as that contained in lead sulfate. In other examples, the lead-bearing material may include a medium amount of sulfur (from about 2 to about 3%), or a much smaller or trace amounts of sulfur (from 0 to about 2%).

The lead-bearing material from step 20 is then heated or roasted in step 30 to burn off the sulfur contained therein. The heating or roasting step 30 of the lead-bearing material is typically performed in a furnace 80. This heating or roasting step may be referred to as the primary step of the furnace. Some non-limiting furnaces that may be used in the heating or roasting step include, but are not limited to, tilting furnaces, reverberatory furnaces, and rotary furnaces. An electric furnace may also be used in step 30.

A tilting furnace is an induction melting furnace for lead melting that can be tilted or poured to facilitate introduction of the lead-bearing material (feeding), removal of molten lead (unloading), and control of the process. A reverberatory furnace is a furnace used in smelting in which the fuel is not in direct contact with the lead-bearing material, but is heated by a flame blown over it from another chamber. A rotary furnace is a barrel-shaped instrument that is rotated around its axis when performing the heating or roasting. A tilting furnace is especially desirable in the present process because it can assist in the lancing step discussed below and also assists in easily separating the slag from the lead product. It is contemplated that other furnaces or equipment may be used in heating or roasting of the lead-bearing material.

In embodiments, the furnace used in the present process operates generally from about 900° C. to about 1,300° C. For example, if a tilting furnace is used, the present process generally operates from about 900° C. to about 1,100° C. If a rotary furnace is used, the present process generally operates from about 1,000° C. to about 1,150° C. If a reverberatory furnace is used, the present process generally operates from about 1,200° C. to about 1,300° C.

In embodiments, the furnace used in the present processes operates at a temperature of greater than about 600° C., greater than about 650° C., greater than about 700° C., greater than about 750° C., greater than about 800° C., greater than about 850° C., greater than about 900° C., greater than about 950° C., greater than about 1000° C., greater than about 1050° C., greater than about 1100° C., greater than about 1150° C., greater than about 1200° C., greater than about 1250° C., or greater than about 1300° C.

In embodiments, the furnace used in the present processes operates at a temperature from about 600° C. to about 1300° C., about 600° C. to about 1200° C., about 600° C. to about 1100° C., about 600° C. to about 1000° C., about 600° C. to about 900° C., about 600° C. to about 800° C., about 600° C. to about 700° C., about 700° C. to about 1300° C., about 700° C. to about 1200° C., about 700° C. to about 1100° C., about 700° C. to about 1000° C., about 700° C. to about 900° C., about 700° C. to about 800° C., about 800° C. to about 1300° C., about 800° C. to about 1200° C., about 800° C. to about 1100° C., about 800° C. to about 1000° C., about 800° C. to about 900° C., about 900° C. to about 1300° C., about 900° C. to about 1200° C., about 900° C. to about 1100° C., about 900° C. to about 1000° C., about 1000° C. to about 1300° C., about 1000° C. to about 1200° C., about 1000° C. to about 1100° C., about 1100° C. to about 1300° C., about 1100° C. to about 1200° C., or about 1200° C. to about 1300° C.

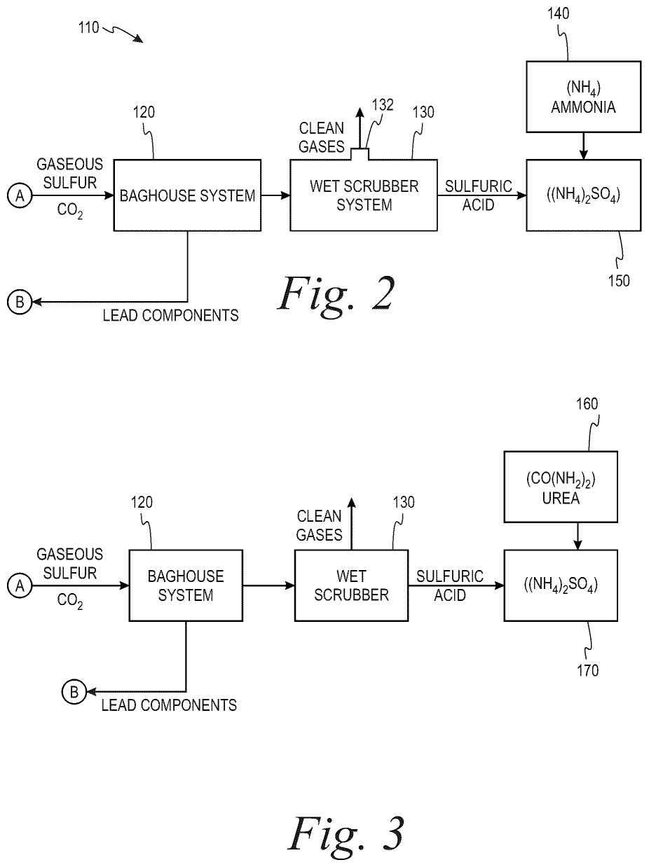

The heating or roasting of the lead-bearing material in the furnace, for example, is configured to burn off the sulfur from the lead-bearing material. The sulfur is cleanly separated from the remainder of the lead-bearing material in the present process during the heating or roasting step 30. The sulfur will substantially or completely burn off in the present process at the temperatures in the furnace. The sulfur is burned off into a gaseous state and forms compounds with oxygen. Some non-limiting examples of sulfur compounds that are formed in the present process include sulfur dioxide (SO₂) and sulfur trioxide (SO₃). It is contemplated that other sulfur compounds such as hydrogen sulfide (H₂S) may be released. The gaseous sulfur compounds are further treated in one process and some non-limiting examples of treatments will be discussed below in conjunction with FIGS. 2 and 3.

In embodiments, the lead-bearing material is heated or roasted in an atmosphere enriched in oxygen or nitrogen. In embodiments, the lead-bearing material is heated or roasted in an atmosphere enriched in oxygen. In embodiments, the lead-bearing material is heated or roasted in an atmosphere enriched in nitrogen.

The lead-bearing material may be desulfurized by other methods besides heating or roasting. For example, sulfur may be removed from lead-bearing material by an electrochemical process, by ammonium treatment, or by magnesium treatment. In embodiments, sulfur may be removed from the lead-bearing material by a process described in U.S. Pat. Nos. 3,972,790, 4,107,007, or U.S. Pat. No. 11,028,460, each of which is incorporated herein by reference in their entirety.

As discussed above, the heating or roasting step 30 is desirably performed in the absence of chemicals. Some chemicals that are not needed or added in the heating or roasting step 30 of the present process include, but are not limited to, sodium ash (sodium carbonate), caustic soda (sodium hydroxide (NaOH)), cast iron, carbon (e.g., charcoal, anthracite), lime, or any combination thereof. By not adding chemical additives, (1) the amount of slag formed in the heating or roasting step 30 is greatly lowered; and (2) the quality of formed the slag (having a greatly reduced amount or absence of hazardous slag) is greatly improved. The heating or roasting step 30 of the present process also eliminates or greatly reduces the amount of dross returned to the furnace.

In embodiments, the heating or roasting step is performed in the absence of a solid carbon source such as anthracite, coke, or coal.

In aspects, the processes comprise a step of removing an additional impurity such as antimony, astatine, chlorine, copper, iron, tin, or zinc.

In embodiments, the composition of the gas produced by the heating or roasting step comprises greater than about 10% SO₂, greater than about 20% SO₂, greater than about 30% SO₂, greater than about 40% SO₂, greater than about 50% SO₂, greater than about 60% SO₂, greater than about 70% SO₂, greater than about 80% SO₂, greater than about 90% SO₂, or greater than about 95% SO₂.

After the sulfur is burned off during the heating or roasting step 30 in the furnace, a molten lead oxide product will remain in the furnace. The lead remaining from the lead-bearing material after the heating or roasting step 30 is typically in the form of lead (II) oxide (PbO) and lead oxide (PbO₂).

In embodiments, the lead oxide content is greater than about 20%, 30%, 40%, 50%, 60%, 70%, 80%, 90%, 95% or more of the desulfurized lead-bearing material. In embodiments, the lead oxide content is greater than about 30% of the desulfurized lead-bearing material. In embodiments, the lead oxide content is greater than about 40% of the desulfurized lead-bearing material. In embodiments, the lead oxide content is greater than about 50% of the desulfurized lead-bearing material. In embodiments, the lead oxide content is greater than about 60% of the desulfurized lead-bearing material. In embodiments, the lead oxide content is greater than about 70% of the desulfurized lead-bearing material. In embodiments, the lead oxide content is greater than about 80% of the desulfurized lead-bearing material. In embodiments, the lead oxide content is greater than about 90% of the desulfurized lead-bearing material. In embodiments, the lead oxide content is greater than about 95% of the desulfurized lead-bearing material.

In embodiments, the lead sulfate content is less than about 1%, 2%, or 5% of the desulfurized lead-bearing material. In embodiments, the lead sulfate content is less than about 1% of the desulfurized lead-bearing material. In embodiments, the lead sulfate content is less than about 2% of the desulfurized lead-bearing material. In embodiments, the lead sulfate content is less than about 5% of the desulfurized lead-bearing material.

In embodiments, the heating or roasting step produces a stable intermediate comprising sulfur. In embodiments, the heating or roasting step produces lead sulfide (PbS).

In embodiments, the amount of PbS in the desulfurized lead-bearing material is less than about 1%, 2%, or 5% of the desulfurized lead-bearing material.

The present process further includes step 40 that introduces a gaseous hydrocarbon. This may be referred to as a secondary process of the furnace. Specifically, the gaseous hydrocarbon from step 40 lances the lead remaining from the lead-bearing material (e.g., lead (II) oxide (PbO) and lead oxide (PbO₂)) in step 50. In one lancing process, the gaseous hydrocarbon is bubbled under the molten lead oxide, reducing the lead oxide to Pb metal by releasing and reacting the hydrocarbon with the oxygen molecules from the lead oxide. This lancing process generates slag that floats on the surface of the molten lead product. The carbon in the hydrocarbon combines with the oxygen molecules in the lead oxide to create carbon dioxide (CO₂), which is released or further processed in step 60. In FIG. 1, the carbon dioxide is shown as being further processed by combining with the gaseous sulfur in its processing as discussed below.

To obtain better efficiency in the reactions between the hydrocarbon and the oxygen molecules from the lead oxide, the lance is moveable in one embodiment. By having the lance moveable, the hydrocarbon more quickly and easily contacts the different oxygen molecules from the lead oxide in the furnace. In addition, by having the lance moveable relative to the furnace enables the lancing process to start and end quicker.

In an embodiment, the lance is submerged in the molten lead oxide product. In an embodiment, the lance is introduced to the molten lead oxide product from above. In an embodiment, the lance is introduced to the molten lead oxide product from below. In an embodiment, the lance is introduced to the molten lead oxide product before beginning gas flow. In an embodiment, the lance is introduced to the molten lead oxide product after beginning gas flow.

The lance in one embodiment is a long metallic (e.g., stainless steel) tube that introduces the gaseous hydrocarbon into the furnace to contact the molten lead oxide product. The gaseous hydrocarbons in the lance are pressurized generally from about 20 to 40 psi in one embodiment. To prevent or enable buildup of material within the lance, the lance is turned on slightly before entering the furnace so that there is flow when entering the furnace and remains on slightly after being removed from the furnace. In embodiments, the lance comprises a plurality of tubes. Each tube may be used to deliver a gas or liquid to the molten lead product.

In an embodiment, the lance comprises a ceramic portion to reduce corrosion or wear to the lance. In embodiments, the lance comprises a component described in U.S. Pat. Nos. 4,251,271, 5,505,762, U.S. Pat. No. 813,329, U.S. Pat. No. 10,113,800, or U.S. Pat. No. 10,260,815, each of which is incorporated herein by reference in its entirety.

Some non-limiting examples of hydrocarbons that may be used in step 40 include methane (CH₄), ethane (C₂H₆), propane (C₃H₈), butane (C₄H₁₀), or any combination thereof. One commonly used example of a hydrocarbon is natural gas, which consists primarily of methane. Natural gas further includes much smaller amounts of ethane, propane, and butane, and may also include other components such as nitrogen, oxygen and carbon dioxide therein. It is contemplated that other hydrocarbons may be introduced in step 40. Like in the heating and roasting step 30, the lancing step 50 desirably does not need or add any chemicals.

The amount of gaseous hydrocarbon used will depend on the amount of lead (II) oxide or lead oxide (PbO₂) after step 30. The amount of gaseous hydrocarbon used is greater than about 3 ft³ per kg of lead (II) oxide present in the desulfurized lead bearing material.

In embodiments, the amount of gaseous hydrocarbon used is greater than about 3 ft³ per kg of lead (II) oxide present in the desulfurized lead bearing material. In embodiments, the amount of gaseous hydrocarbon added is greater than about 5%, 10%, 15%, 20%, 25%, 30%, or 35% by mass with respect to the amount of lead oxide present. In embodiments, the amount of gaseous hydrocarbon added is about 5%, about 10%, about 15%, about 20%, about 25%, about 30%, or about 35% by mass with respect to the amount of lead oxide present.

After the lancing step 50 has been completed, the components in the furnace include lead, carbon dioxide (CO₂), and slag. This may be referred to as furnace material. As discussed above, the slag is desirably non-hazardous slag. It is contemplated in other processes that the slag may contain a minimal amount of hazardous slag. If such hazardous slag is present, it would be of a nominal amount such as from 0 to about 3%. Having any hazardous slag is also undesirable because this often includes metals that are not only costly to further process, but any metals included therein are not being reprocessed and are, thus, wasted. The carbon dioxide is removed from the lead oxide and the slag in step 60. The carbon dioxide is desirably at very clean level and may not need further processing. In FIG. 1, the carbon dioxide is shown as being further processed by combining with the gaseous sulfur in its processing as discussed below.

The remaining molten lead and slag are then separated. The slag is lighter than the molten lead, which makes it easier to separate. The slag floats on the molten lead and can be separated from the molten lead by, for example, overflowing from a slag pot when using a tilting furnace or ladled off when both are still warm. It is contemplated that other process may be used to separate the slag and the lead when both are still warm. In another process, the slag may be separated from the molten lead when both are in a solid state. These resulting products are shown in steps 62 and 64, respectfully, in the process flow chart 10 of FIG. 1.

The molten lead product formed in step 62 is typically greater than 95% lead and may be greater than 97 or 97.5% lead. The molten lead product may be referred as crude lead. The molten lead product formed in step 62 may include small amounts of impurities such as antimony, tin, copper and arsenic. These small amounts of impurities in the molten lead product formed from the furnace are removed in further processing. This is shown in step 66 where the formed molten lead in step 62 may be further refined to obtain a higher purity of lead. For example, the lead product may be purified to obtain greater than 99.0% lead. In another process, the lead product may be refined to at least 99.5%, 99.7% or 99.85% lead. The lead product is often refined to a desired specification. During the refining process of the lead, a small percentage of the lead is typically formed in lead alloys. This may be referred to as final goods.

There are several processes for further refining the molten lead product from the furnace after the lancing step 50. For example, the lead may be melted and again allowed to cool to remove impurities by adding chemicals, which generates by-process dross that may be removed by skimming. The lead product may be processed in the furnace again. There are several known individual techniques to eliminate the remaining metals in the molten lead product. For example, a blast of air may be used to oxidize any remaining antimony or arsenic, both of which harden lead, and the antimony and arsenic are then skimmed off. The copper and tin may be removed by other processes form the molten lead product. The non-hazardous slag in step 64 may be further processed into non-hazardous waste disposal in step 68. For example, if the slag is leachable, the non-hazardous slag may be treated with cement. The non-hazardous slag may be crushed such that metallic portions can be visually removed.

Referring to FIG. 2, a process flow chart 110 shows processing of the gaseous sulfur compounds after being burned off from the furnace in step 30 described above. There are several techniques for treating the gaseous sulfur components and which one is selected depends on the desired final product. One non-limiting process in FIG. 2 for treating the gaseous sulfur compounds includes a baghouse system 120 followed by a wet scrubber system 130. The baghouse system 120 includes a series of filters that are configured to filter out non-gaseous components of the gaseous sulfur compounds. After these components are filtered out, the remaining gaseous sulfur is sent through the wet scrubber system 130. The wet scrubber system 130 cleans the gases and any remaining dust using water in a bath. The cleaned gasses then may be emitted through a stack 132 to the atmosphere.

The baghouse system 120 is typically operated at temperatures from about 80 to about 100° C. The number of filters in a baghouse system may be in the hundreds or thousands in embodiments. The filtered material desirably includes all of the lead components that escaped the furnace 80. The filtered material (which may include lead components) from the baghouse system 120 may be returned to the furnace 80.

The wet scrubber system 130 assists in forming sulfuric acid (H₂SO₄) when the sulfur oxides react with the water in the bath. The water in the wet scrubber system 130 is typically pumped like a rainfall on the sulfur oxides. After the sulfuric acid is formed, the sulfuric acid is separated out.

In one process, the sulfuric acid is then reacted with ammonia (NH₄) of step 140 to form ammonium sulfate ((NH₄)₂SO₄) in step 150. Ammonium sulfate is a valuable by-product that may be used in fertilizer. Ammonium sulfate may be used in other products such as detergents and other applications in the chemical, textile and pharmaceutical industries.

In another process, urea (CO(NH₂)₂) may be reacted with sulfuric acid to form ammonium sulfate ((NH₄)₂SO₄). This is shown in FIG. 3 and includes the above described baghouse system 120 and the wet scrubber system 130. But, instead of ammonia in step 140, urea in step 160 is added to react with the sulfuric acid to form ammonium sulfate ((NH₄)₂SO₄) in step 170.

In another process, the sulfuric acid may be reacted with sodium ash (sodium carbonate) to form sodium sulfate (NaSO₄), carbon dioxide, and water. In another process, the sulfuric acid may be reacted with magnesium hydroxide, Mg(OH)₂ to form magnesium sulfate (MgSO₄) and water. In a further process, the sulfuric acid may be a finalized final product. Sulfuric acid may be used in different processes including, for example, paper processes, drain cleaners, leather industry, and restoring exhausted car batteries.

There may be additional components used in the further processing of the gaseous sulfur compounds. These include, but are not limited to, a dust collector that collects the gaseous material exiting the furnace, a cyclone that connects to the dust collector and assists in removing solids that may be returned to the furnace, and a cooling tower that cools the gaseous material before entering the bag house system.

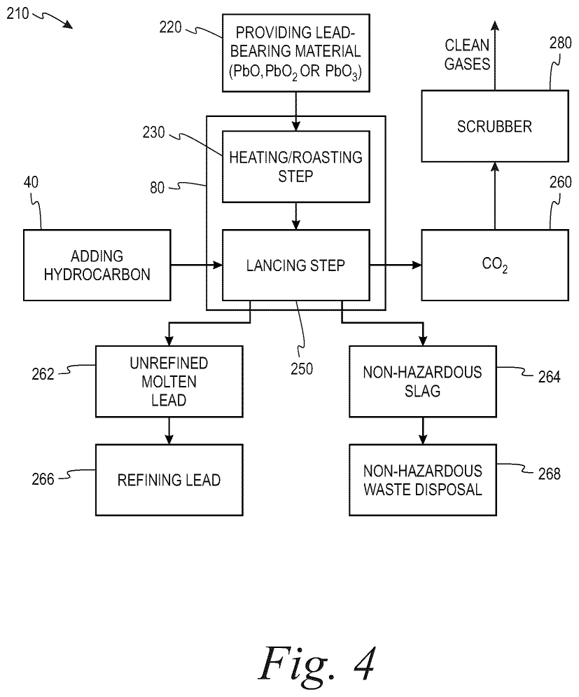

Referring to FIG. 4, a process flow chart 210 includes step 220 that provides lead-bearing material without sulfur. Some non-limiting examples are lead (II) oxide (PbO), lead oxide (PbO₂), and lead carbonate (PbCO₃). The lead-bearing material without sulfur enters the furnace 80 and then is heated or roasted in step 230. The heating or roasting step 230 is the same as the heating or roasting step 30 except for the starting material.

After the lead-bearing material in step 220 is heated or roasted in the furnace 80, hydrocarbons in step 40 are added in a lancing step 250. The lancing step 250 is the same as the lancing step 50 described above except that the starting material may be a bit different. The carbon dioxide formed in step 260 from the lancing is sent a scrubber 280 for additional cleaning, resulting in clean gases being emitted. After the lancing step 250, the components in the furnace 80 include lead, carbon dioxide and slag. The slag is desirably non-hazardous slag. The remaining molten lead and slag are separated into step 262 (unrefined molten lead) and into step 264 (non-hazardous slag). Steps 262 and steps 264 are the same as described above in steps 62, 64, respectively. The unrefined molten lead in step 262 may be further refined in step 266, which is the same as described above in step 66. The non-hazardous slag in step 264 may be further processed into non-hazardous waste disposal in step 268, which is the same as described above in step 68.

### EXAMPLES

The function and advantages of these and other embodiments can be better understood from the following examples. These examples are intended to be illustrative in nature and are not considered to be in any way limiting the scope of the invention.

### Constructive Example 1: Separation of Lead-Bearing Material

In this example, scrap lead-acid batteries are processed to isolate lead-bearing material. First, scrap lead-acid batteries are broken by a mechanical means. The remaining solid components of the battery are transferred to a sink-float cell where the high-density materials (e.g., metal components) are separated from the plastic components by density. The high-density fraction includes both lead-bearing materials (e.g., Pb, PbO, PbO₂ and PbSO₄) and other structural metals from the batteries. Further separation steps may be used to separate the lead-bearing materials from other metallic components. The high-density material is milled to an appropriate size (typically less than about 10 mm) before subsequent processing steps.

The lead-bearing material obtained from this process will typically have a composition of between about 65% to about 95% lead (as Pb, PbO, and PbO₂) and between about 2% to about 6% sulfur (e.g., as PbSO₄). Other metals such as, e.g., antimony, arsenic, and tin may also be present in the lead-bearing materials, typically at less than about 2% by mass.

### Constructive Example 2: Preparation of Desulfurized Lead-Bearing Material

In this example, lead-bearing material comprising lead sulfate is processed to remove sulfur. The lead-bearing material is heated in a furnace to between about 900° C. to 1300° C. Sulfur in the form of SO₂ and SO₃ evolves from the system. The reaction is monitored until sulfur production stops. The desulfurized lead-bearing material typically includes less than about 2% sulfur by mass and greater than about 90% PbO by mass. The thermal decomposition process may produce other gaseous species such as: O₂, CO, CO₂ and NOx. Other methods for removing sulfur include electrochemical reduction, ammonium treatment, or magnesium treatment, although these methods would have a higher yield of slag and residues in the material to be smelted therefore reducing the throughput of the process.

### Example 1: Introduction of Gaseous Hydrocarbon to Desulfurized Lead-Bearing Material

In this example, desulfurized lead-bearing material was reduced to metallic lead using a gaseous hydrocarbon source. About 1 kg of solid paste was added to a crucible and heated to between about 850° C. to about 925° C. Once a liquid was formed, natural gas was introduced to the molten desulfurized lead-bearing material through a submerged stainless-steel lance (inner diameter of ⅛ inches) under stirring. The reaction proceeds until greater than about 5% of the mass of the solid paste is introduced to the desulfurized lead-bearing material (greater than about 3 ft³ of natural gas per 1 kg of paste). The temperature was maintained between about 850° C. and 925° C. during this process to burn off any unreacted gas traveling through the molten paste without reacting with available oxygen.

At this stage, the molten paste was inspected to verify completion, as indicated by a shiny surface appearance. The metallic product along with any slag was poured into a mold, and any floating slag is skimmed off from the surface of the metal. The metallic lead was tested by elemental analysis for purity and the identity of any impurities. The smelting process may be repeated as needed until the desired purity is reached.

### Comparative Example 1

In this example, the process of Example 3 was compared to a process using a solid carbon source (anthracite) and soda ash instead of a gaseous hydrocarbon. About 1 kg of desulfurized lead-bearing material was added to a crucible along with about 60 mg of anthracite and soda ash and the temperature was maintained between about 850° C. and 925° C. The metallic lead and slag were separated as described in Example 3. As shown in Table 1, the process of Example 3 produced substantially less slag than a standard smelting process, and a higher yield of metallic lead.

TABLE 1
Slag produced from 1 kg starting desulfurized lead-bearing material

| | | Reduction with solid |
|---|---|---|
| | Example 3 | carbon source |
| Metallic lead produced (g) | 740 | 650 |
| Purity (%) | 98 | 98 |
| Slag mass (g) | 50 | 260 |

The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

What is claimed is:

1. A process for producing metallic lead from scrap lead-acid batteries, the process comprising:
processing scrap lead-acid batteries to separate lead-bearing material from non-lead bearing material;
removing sulfur present in the lead-bearing-material to produce a desulfurized lead-bearing material; and,
introducing a gaseous hydrocarbon to the desulfurized lead-bearing material to produce metallic lead.

2. The process of claim 1, wherein the lead-bearing material comprises lead (II) sulfate (PbSO₄).

3. The process of claim 1, wherein the step of removing sulfur from the lead-bearing material comprises heating the lead-bearing material.

4. The process of claim 3, wherein the step of heating the lead-bearing material comprises heating at a temperature greater than about 800° C.

5. The process of claim 3, wherein the step of heating the lead bearing material comprises heating at a temperature of between about 800° C. to about 1300° C.

6. The process of claim 1, wherein the step of removing sulfur from the lead-bearing material is performed without the use of a pyrometallurgical flux.

7. The process of claim 6, wherein the pyrometallurgical flux is a solid carbon source.

8. The process of claim 1, wherein the step of introducing a gaseous hydrocarbon to the desulfurized lead-bearing material comprises use of a lance.

9. The process of claim 8, wherein the gaseous hydrocarbon comprises a C₁-C₆ alkane.

10. The process of claim 9, wherein the amount of C₁-C₆ alkane introduced is greater than about 5% by mass with respect to the amount of desulfurized lead-bearing material.

11. The process of claim 9, wherein the amount of C₁-C₆ alkane introduced is between about 5% to about 30% by mass with respect to the amount of desulfurized lead-bearing material.

12. The process of claim 1, wherein the step of introducing a gaseous hydrocarbon to the desulfurized lead-bearing material is performed in the absence of a pyrometallurgical flux.

13. The process of claim 12, wherein the pyrometallurgical flux is a solid carbon source.

14. The process of claim 13, wherein the solid carbon source is anthracite, coal, or coke.

15. The process of claim 1, further comprising the step of separating metallic lead from a slag material.

16. The process of claim 1, further comprising the step of measuring the purity of the metallic lead.

17. A process for producing metallic lead, the process comprising:
providing a desulfurized lead-bearing material; and,
introducing a gaseous hydrocarbon to the desulfurized lead-bearing material to produce metallic lead.

18. A system for processing a lead-bearing material to produce lead, the system comprising:
a furnace for heating the lead-bearing material at a temperature and time sufficient to remove sulfur present in the lead-bearing material;
a separation system for separating any gaseous sulfur compounds produced by heating the lead-bearing material; and,
a source of a gaseous hydrocarbon connected to the furnace and constructed and arranged to introduce the gaseous hydrocarbon to the desulfurized lead-bearing material in an amount and for a period of time sufficient to produce metallic lead.

19. The system of claim 18, wherein the furnace operates at a temperature of between about 600° C. to about 1200° C.

20. The system of claim 18, wherein the separation system comprises a baghouse system.

21. The system of claim 18, wherein the separation system comprises a wet scrubber system.

22. The system of claim 18, wherein the source of a gaseous hydrocarbon is constructed and arranged to introduce the gaseous hydrocarbon to the desulfurized lead-bearing material by a lance.

23. The system of claim 22, where the lance is moveable relative to the furnace.

24. The system of claim 18, wherein the source of a gaseous hydrocarbon is constructed and arranged to introduce the gaseous hydrocarbon to the desulfurized lead-bearing material at a pressure of between about 10 psi to about 40 psi.

25. A process for retrofitting a smelting system, the process comprising:
providing a lance in connection with a source of a gaseous hydrocarbon; and,
positioning the lance in connection with the source of gaseous hydrocarbon with a furnace of the smelting system.

26. A process for the recovery of lead, the process comprising:
providing lead-bearing material, the lead-bearing material comprising PbSO₄;
heating the lead-bearing material to produce gaseous sulfur compounds and lead oxide;
separating the gaseous sulfur compounds and the lead oxide;
lancing the lead oxide with a gaseous hydrocarbon resulting in the formation of lead (Pb) and carbon dioxide (CO₂); and
separating the lead and the carbon dioxide.

27. The process of claim 26, further comprising the step of reacting the gaseous sulfur compounds with water to form sulfuric acid (H₂SO₄).

28. The process of claim 27, further including reacting the sulfuric acid with ammonia (NH₄) to form ammonium sulfate ((NH₄)₂SO₄).

29. The process of claim 27 further including reacting the sulfuric acid with urea (CO(NH₂)₂) to form ammonium sulfate ((NH₄)₂SO₄).

30. The process of claim 26, wherein the lancing forms non-hazardous slag.

31. The process of claim 26, wherein the heating of the lead-bearing material is performed in a tilting furnace, a reverberatory furnace or a rotary furnace.
